(19) United States
(12) Patent Application Publication
(10) Pub. No.: US 2012/0142388 A1
(43) Pub. Date: Jun. 7, 2012

(54) SYSTEMS, APPARATUS AND METHODS FOR RESOURCE LIMITATION

(75) Inventors: Swaroop Sampath Kumar, Singapore (SG); Pek Yew Tan, Singapore (SG); Terufumi Takada, Kanagawa (JP)

(73) Assignee: Panasonic Corporation, Osaka (JP)

(21) Appl. No.: 13/389,524

(22) PCT Filed: Aug. 13, 2009
(86) PCT No.: PCT/JP2009/003892

§ 371 Date: Feb. 8, 2012

(51) Int. Cl. H04W 72/04

(52) U.S. Cl. 455/509

(57) ABSTRACT

Systems, apparatus and methods for resource limitation in wireless networks are disclosed. The invention addresses the problem of allowing all network users at least some network resources during emergency and other similar situations. The invention transfers filters used for communications from guaranteed bit rate radio bearers to non-guaranteed bit rate radio bearers upon indication of emergency or other similar situations.

### TECHNICAL FIELD

This invention relates to wireless networks and more particularly relates to resource limitation in a wireless network.

### BACKGROUND ART

Resource management is a major concern in wireless networks such as those based on Long Term Evolution (LTE). In particular, resource management during emergency situations, when resources need to be conserved, is important for wireless network operators. During such situations, it may be beneficial to limit usage of network resources to provide emergency services such as alerts and warnings. For instance, during an earthquake, it would be beneficial to limit network usage for multimedia services and provide warnings over the wireless network.

Wireless network operators sometimes handle resource management in emergency situations by completely restricting access to network resources for a subset of network users and their User Equipment (UE). This has the effect of conserving network resources, however at the expense of preventing some users from any communications.

A Prior art discusses access class barring as a mechanism for resource management during emergency and other similar situations. With this mechanism, wireless network UEs are randomly assigned different access classes. Then during emergencies, certain access classes are barred from accessing network resources. By doing so, the mechanism allows network resources to be limited to only a certain percentage of UEs. However, this mechanism has the drawback of completely preventing some UEs from accessing the network.

The prior art discussed insofar illustrates the absence of existing mechanisms to address the need for resource management that allows all UEs at least some access to network resources for communications during emergency and similar situations.

### Citation List

Non Patent Literature

NPL 1: 3GPP TS 22.011, “Service Accessibility”

NPL 2: 3GPP TS 24.301 “Non-Access-Stratum (NAS) protocol for Evolved Packet System (EPS)”

### SUMMARY OF INVENTION

During emergency and other similar situations, it is desirable to allow all users at least some access to network resources for communications. This may be achieved by providing sufficient network resources to perform low bit-rate communications such as web browsing. Such an approach allows users to be updated with the latest news and information.

During emergency and other similar situations, if the network can provide just non-Guaranteed Bit Rate (non-GBR) bearers, it can control network resources such as bandwidth usage. Non-GBR bearers do not guarantee Quality of Service (QoS), so all UEs can access at least some bandwidth without guaranteed QoS.

However, moving data from non-GBR bearers to Guaranteed Bit Rate (GBR) bearers may not be efficient as context information will be lost when the network sets up only the non-GBR bearer. Users may have many applications running and they may expect their applications to return to normal QoS levels after the emergency and other similar situations when resource availability returns to normal. In this case, the applications need to setup contexts for GBR bearers again and this impacts applications. Setup of contexts in relation to resource limitation is purely a NAS level functionality and applications should be hidden from these complexities.

In view of the above discussed problems, it is the objective of the present invention to provide systems, apparatus and methods for resource limitation by moving filters for one set of bearers to a default bearer during periods of network resource limitation.

It is another objective of the invention to provide systems, apparatus and methods for resource limitation by storing current bearer contexts, frozen bearer contexts, for one set of bearers to be used for future synchronization after network resource limitation is removed.

It is yet another objective of the invention to provide systems, apparatus and methods for resource limitation by re-synchronizing frozen bearer contexts after network resource limitation is removed.

The present invention addresses the problems relating to resource control in networks during emergency and other similar situations.

In its broadest aspect, the present invention provides a system of resource limitation comprising of a UE that on enforcement of resource limitation by radio network, moves filters from bearer contexts corresponding to unestablished bearers to default bearer context when default bearer has a TFT and stops UE requested QoS modification procedure until resource limitation enforcement by the network has been removed and a network node that upon being informed of enforcement of resource limitation by radio network, moves filters from bearer contexts corresponding to unestablished bearers to default bearer when default bearer has a TFT

In a further aspect, the UE on detection of enforcement of resource limitation and unestablished bearers, stores the current context as a frozen bearer context for future synchronization with the network node.

In another aspect, the current invention presents a method of resource limitation enforcement comprising the steps of detecting by the UE of resource limitation enforcement by the radio network, moving filters of unestablished bearers to default bearer in case of presence of TFT in default bearer, stopping further UE requested QoS modification procedures until the resource limitation enforcement is stopped by the radio network, indicating resource limitation enforcement to the network node and network node moving filters of unestablished bearers to default bearer in case of presence of TFT in default bearer.

In a further aspect, the method comprises the step of the UE storing the current bearer context as a frozen bearer context information.

### BRIEF DESCRIPTION OF DRAWINGS

FIG. 1 illustrates a UE operating in accordance with an embodiment of the invention.

FIG. 2 depicts a network node operating in accordance with an embodiment of the invention.

FIG. 3 illustrates a sequence of operations of an embodiment of the invention.

FIG. 4 illustrates a flowchart of a sequence of operations of a UE or network node in accordance with the invention.

FIG. 5 depicts a sequence of operations of an embodiment of the invention.

FIG. 6 illustrates a flowchart of a sequence of operations of a UE or network node in accordance with the invention.

FIG. 7 illustrates a flowchart of a sequence of operations of a UE or network node in accordance with the invention.

FIG. 8 illustrates a flowchart of a sequence of operations of a UE or network node in accordance with the invention.

### DESCRIPTION OF EMBODIMENTS

In the following description, for the purpose of explanation, specific numbers, times, structures and other parameters are set forth in order to provide a thorough understanding of the present invention. However, it will be apparent to those skilled in the art that the present invention may be practiced without these specific details or may be practiced with variations of these details.

### Embodiment 1

The present invention provides systems, apparatus and methods for resource limitation in wireless networks.

When a UE has uplink data or signaling, it will initiate a service request. In accordance with one embodiment of the invention, the UE will then be notified by its lower layers that resource limitation is in effect. The UE then checks for established bearers. If some dedicated bearers are not established, the UE checks if the default bearer context has filters assigned to it after recognizing resource limitation is in effect. If the default bearer context has TFT, the UE transfers the TFTs from dedicated bearer contexts to the default bearer context. The UE then proceeds with uplink data transmission once default bearer is established. If the default bearer context does not have TFTs, UE may delete the dedicated bearer contexts and proceed with uplink data transmission using the default bearer. After this, the UE will stop any QoS modification procedure requested by its applications until resource limitation is removed. Once resource limitation is removed, UE will allow requests for QoS modification.

The network may re-initiate dedicated bearers for premium users during resource limitation being in effect. The network may re-initiate dedicated bearers for all users after resource limitation is removed. The UE may also re-initiative dedicated bearer activation after resource limitation is removed.

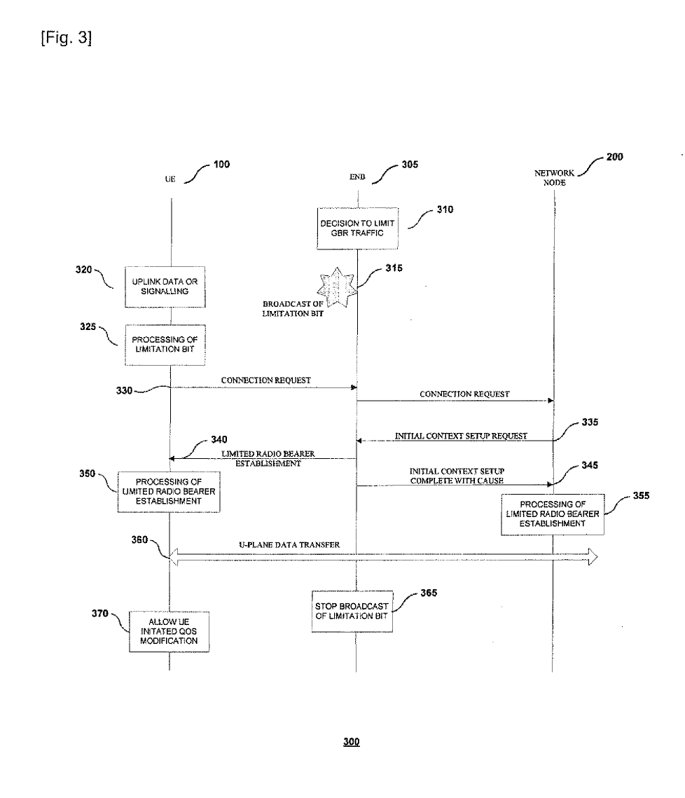

FIG. 3 illustrates a sequence of operations (300) for this embodiment of the present invention. Sequence (300) is exemplified by UE (100), eNode-B (ENB) (305) and Network Node (NN) (200). UE (100), ENB (305) and NN (200) may operate according to any of a singular or plurality of wireless technologies including GSM, UMTS, CDMA2000, LTE and WiMAX. In an exemplification of this embodiment, UE (100), ENB (305) and NN (200) operate in according with 3GPP LTE. NN (200) is representative of a network comprising mobile management entity (MME), P-Gateway and other network entities. ENB (305) provides the LTE radio interface to UE (200).

The present invention is assumed to be applicable when UE (100) is in idle mode. In one aspect of the invention in which UE (100) is in connected mode, ENB (305) first releases the radio resource control (RRC) connection with UE (100). This causes UR (100) to change to idle mode from which the invention is applicable.

In accordance with the invention, an emergency or similar situation will result in ENB (305) deciding to limit GBR traffic over the radio interface between UEs and ENB of the network. This decision may be triggered by an external source such as emergency warning system or network operator. Upon receiving such a trigger, ENB (305) sends a resource limitation bit over the radio interface in a step (315). The resource limitation bit serves to notify UE (200) and other UEs of emergency or other similar situations. It also serves to notify UE (200) and other UEs that resource limitation is to be performed and that resource limitation is “ON”. The step (315) may be realized by broadcasting the resource limitation bit, including a new indication in RRC message from every service request, updating an appropriate System Information Block, sending Paging to UE (200) and other UEs or by other similar mechanisms. In one aspect of the embodiment, RRC layer of UE (200) receives notification that resource limitation is “ON”.

In a step (320), UE (100) has data or signaling and attempts to establish uplink connection. The step (320) involves NAS layer of UE (100) sending a notification to RRC layer of UE (100). At this time, NAS layer will receive notification from RRC layer that resource limitation is “ON”.

Then in a step (325), NAS layer of UE (100) processes the notification of resource limitation being “ON”. After, UE (100) sends a connection request in a step (330). The connection request may be a service request message or other message of similar intent. The connection request message is received by ENB (305) and forwarded to NN (200).

After receiving connection request from UE (100), NN (200) initializes bearer establishment and sends initial context setup request to ENB (305) in a step (335). Then in a step (340), ENB (305) establishes only non-GBR bearers including the default bearer with UE (100).

In a step (345), ENB (305) provides a cause value to NN (200) notifying NN (200) of resource limitation being “ON”. In one aspect of the embodiment, ENB (305) sends a S1-AP message with new cause value to NN (200) for the indication of not establishing GBR bearers. In another aspect of the embodiment, UE (100) changes connection request message from type service request to type extended service request during resource limitation.

In a step (350), UE (100) processes the establishment of limited radio bearers. The NAS layer of UE (100) transfers existing filters of dedicated bearers to the default bearer. The step (350) ensures that UE (100) will have at least some access to the network resources for communications in the form of access to non-GBR default bearer.

In a step (355), NN (200) processes the establishment of limited radio bearers. The NAS layer of NN (200) transfers existing filters of dedicated bearers to the default bearer. In one aspect of the invention, the filters may be traffic flow templates (TFT) for bearers. The step (355) ensures that NN (200) will allow UE (100) to have at least some access to the network resources for communications in the form of access to non-GBR default bearer.

After the transfer of filters, UE (100) conducts user plane data transfer in a step (360). In this step, UE (100) may also conduct signaling for applications such as SIP signaling for IMS applications. All communications between UE (100) and the network takes place through non-GBR bearers including the default bearer.

In a step (365) after ENB (205) receives trigger that resource limitation should be removed, ENB (205) stops sending the resource limitation bit over the radio interface. Step (365) serves to indicate to UE (100) and other UEs that resource limitation has ended and that resource limitation is “OFF”. The step (365) may be realized by stopping broadcast of the resource limitation bit, updating an appropriate System Information Block or sending Paging to UE (200) and other UEs or by other similar mechanisms. In one aspect of the embodiment, RRC layer of UE (200) recognizes that resource limitation is “OFF” and sends a message to the NAS layer of (200).

After recognizing that resource limitation is “OFF”, UE (200) returns to use the previously used bearer contexts. In a step (370), UE (100) re-allows initiation of QoS modification to establish its previously used bearer contexts. In one aspect of this embodiment, UE (200) sends a message to NN (200) indicating the new bearer context status. This can be sent via a bearer context status information element (ID) or other similar notification to NN (200). In another aspect of the embodiment, NN (200) may receive a message from an external source indicating resource limitation is “OFF”.

Upon recognizing resource indication is “OFF”, NN (200) checks the bearer context status IE from UE (100) and resynchronizes bearer context status with UE (100). NN (200) proceeds to establish the remaining dedicated bearers for UE (100).

“Details of Processing Limited Radio Bearer Establishment”

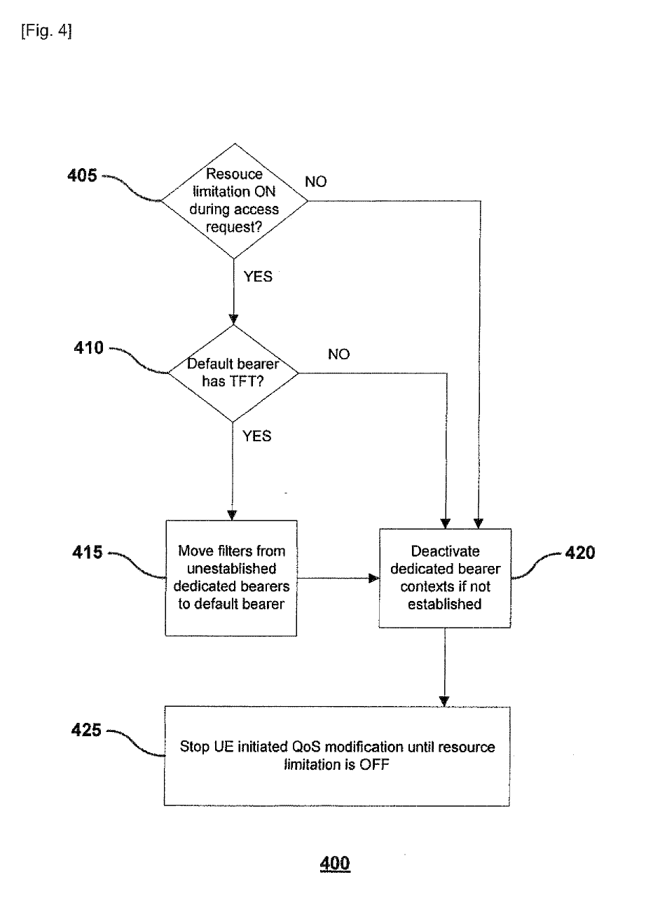

Flowchart (400) of FIG. 4 illustrates the operations comprising steps (350) and (355) of processing the establishment of limited radio bearers by UE (100) and NN (200), respectively. In a step (405), UE (100) checks if resource limitation is “ON” during request to access network resources. Step (405) may be accomplished by NAS layer of receiving messages from RRC layer indicating that state of resource limitation.

If the check of step (405) results in a recognizing resource limitation is “ON”, UE (100) then checks if the default bearer has TFTs in a step (410). If the default bearer has TFTs, then in a step (415), TETs from unestablished dedicated bearers are transferred to the default bearer. In a step (420), unestablished dedicated bearer contexts are deactivated.

Then in a step (425), UE (100) is prevented from initiating QoS modifications until resource limitation is “OFF”. The step (425) may be accomplished by UE (100) by the NAS layer sending error notification to applications when QoS modifications are requested. The step (425) may be accomplished by NN (200) by rejecting QoS modification requests with an error cause. The step (425) may also be accomplished by UE (100) and NN (200) by other means.

In the event that resource limitation is “OFF” or the default bearer context does not have TFTs, then step (420) is performed directly.

### Embodiment 2

In another embodiment of the present invention, when resource limitation is in effect, bearer contexts of dedicated bearers are stored or “frozen” before transferring TFTs of these bearer contexts to the default bearer context. Then later, when resource limitation is removed, the “frozen” bearer contexts are used.

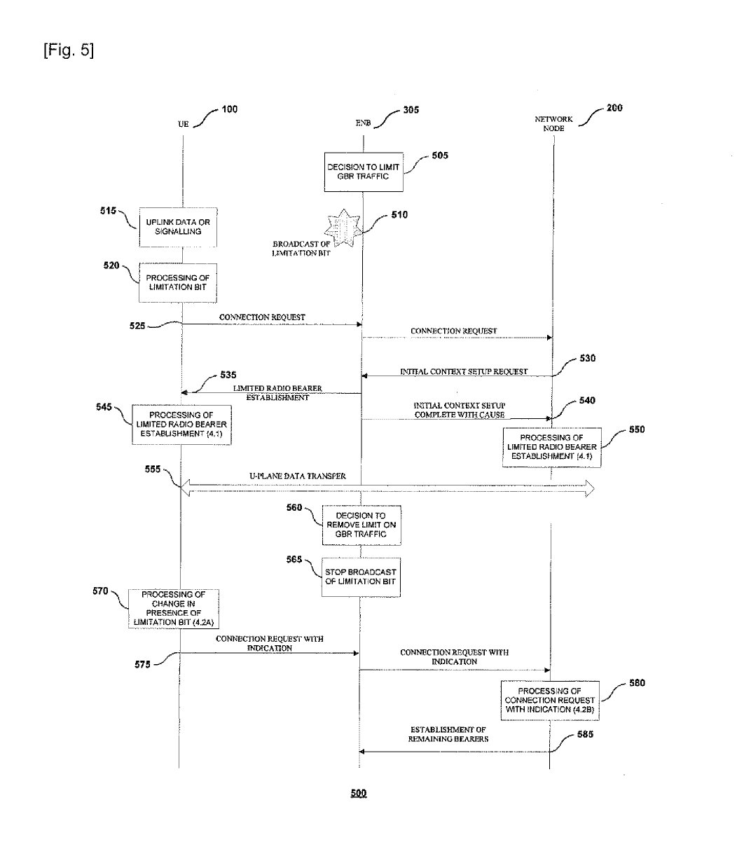

Sequence (500) of FIG. 5 illustrates this embodiment. Sequence (500) is exemplified by UE (100), eNode-B (ENB) (305) and Network Node (NN) (200).

In accordance with the invention, an emergency or similar situation will result in ENB (305) deciding to limit GBR traffic over the radio interface between UEs and ENB of the network. This decision may be triggered by an external source such as emergency warning system or network operator. Upon receiving such a trigger, ENB (305) sends a resource limitation bit over the radio interface in a step (505). The resource limitation bit serves to notify UE (200) and other UEs of emergency or other similar situations. It also serves to notify UE (200) and other UEs that resource limitation is to be performed and that resource limitation is “ON”. The step (505) may be realized by broadcasting the resource limitation bit, including a new indication in RRC message from every service request, updating an appropriate System Information Block, or sending Paging to UE (200) and other UEs or by other similar mechanisms. In one aspect of the embodiment, RRC layer of UE (200) receives notification that resource limitation is “ON”.

In a step (515), UE (100) has data or signaling and attempts to establish uplink connection. The step (515) involves NAS layer of UE (100) sending a notification to RRC layer of UE (100). At this time, NAS layer will receive notification from RRC layer that resource limitation is “ON”.

Then in a step (520), NAS layer of UE (100) processes the notification of resource limitation being “ON”. After, UE (100) sends a connection request in a step (525). The connection request may be a service request message or other message of similar intent. The connection request message is received by ENB (305) and forwarded to NN (200).

After receiving connection request from UE (100), NN (200) initializes bearer establishment and sends initial context setup request to ENB (305) in a step (530). Then in a step (535), ENB (305) establishes only non-GBR bearers including the default bearer with UE (100).

In a step (540), ENB (305) provides a cause value to NN (200) notifying NN (200) of resource limitation being “ON”. In one aspect of the embodiment, ENB (305) sends a S1-AP message with new cause value to NN (200) for the indication of not establishing GBR bearers. In another aspect of the embodiment, UE (100) changes connection request message from type service request to type extended service request during resource limitation.

In a step (545), UE (100) processes the establishment of limited radio bearers. If the default bearer has a TFT, the NAS layer of UE (100) transfers existing filters of dedicated bearers to the default bearer. The step (545) ensures that UE (100) will have at least some access to the network resources for communications in the form of access to non-GBR default bearer.

In a step (550), NN (200) processes the establishment of limited radio bearers. The NAS layer of NN (200) transfers existing filters of dedicated bearers to the default bearer. In one aspect of the invention, the filters may be traffic flow templates (TFT) for bearers. The step (550) ensures that NN (200) will allow UE (100) to have at least some access to the network resources for communications in the form of access to non-GBR default bearer.

After the transfer of filters, UE (100) conducts user plane data transfer in a step (555). In this step, UE (100) may also conduct signaling for applications such as SIP signaling for IMS applications. All communications between UE (100) and the network takes place through non-GBR bearers including the default bearer.

In a step (560), ENB (205) makes a decision to remove limit on GBR traffic. This decision may be triggered by external sources such as emergency warning system or network operator.

Then in a step (565) after ENB (305) receives trigger that resource limitation should be removed, ENB (305) stops sending the resource limitation bit over the radio interface. Step (565) serves to indicate to UE (100) and other UEs that resource limitation has ended and that resource limitation is “OFF”. The step (565) may be realized by stopping broadcast of the resource limitation bit, updating an appropriate System. Information Block, sending Paging to UE (100) and other UEs or by other similar mechanisms. In one aspect of the embodiment, RRC layer of UE (100) recognizes that resource limitation is “OFF” and sends a message to the NAS layer of UE (100).

After recognizing that resource limitation is “OFF”, UE (100) processes the chance in the presence of the limitation bit in a step (570). In this step, UE (100) sends a message to the network to indicate resource limitation is “OFF”. UE (100) sends connection request with the indication of resource limitation “OFF” is a step (575). The message of step (575) may be tracking area update message or a service request message. ENB (305) receives the message of step (575) and forwards it to NN (200).

In one aspect of the embodiment, UE (100) in step (575), sends connection request message of type service request while in connected mode. Since UE does not send service request in connected mode, NN (200) recognizes that UE (100) seeks to synchronize “frozen” context.

In another aspect of the embodiment, UE (100) in step (575), sends connection request message of type tracking area update with bearer context status and an indication of resource limitation being “OFF”.

In yet another aspect of the embodiment, UE (100) in step (575), sends extended service request with bearer context status and an indication of resource limitation being “OFF”.

Upon receiving message of step (575), NN (200) processes the connection request with indication of resource limitation “OFF” in a step (580). In this step, NN (200) synchronizes bearer contexts with UE (100). NN (200) proceeds to establish the remaining dedicated bearers for UE (100) in a step (585).

“Details of Processing Limited Radio Bearer Establishment”

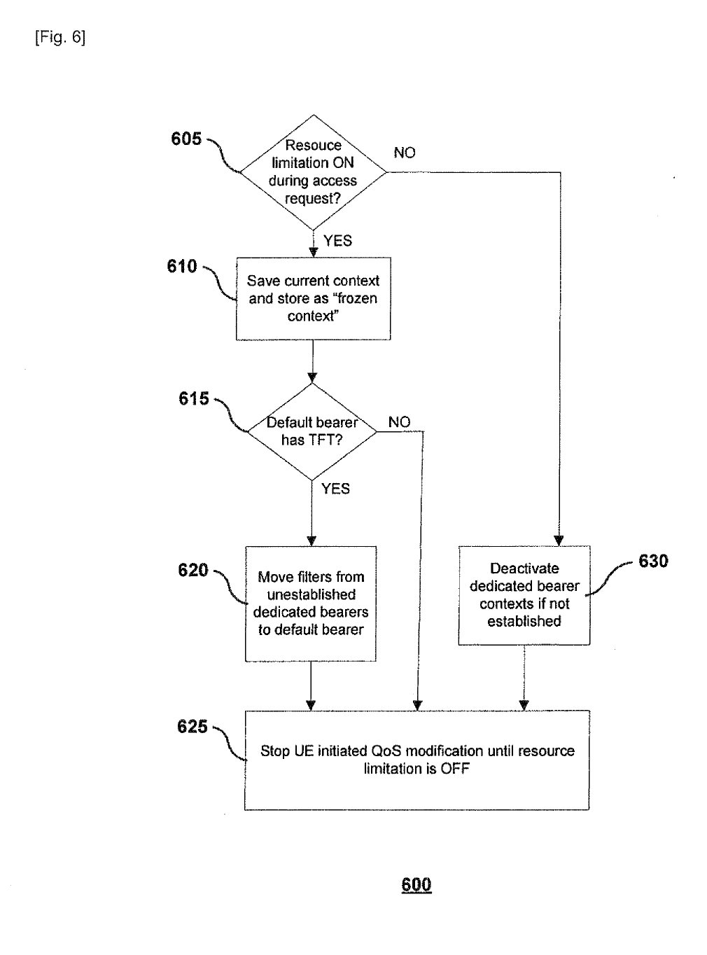

Flowchart (600) of FIG. 6 illustrates the operations comprising steps (545) and (550) of processing the establishment of limited radio bearers by UE (100) and NN (200), respectively. In a step (605), UE (100) checks if resource limitation is “ON” during request to access network resources. Step (605) may be accomplished by NAS layer of receiving messages from RRC layer indicating that state of resource limitation.

If the check of step (605) results in a recognizing resource limitation is “ON”, UE (100) saves the current bearer contexts of the dedicated bearers as “frozen” context in a step (610).

UE (100) then checks if the default bearer has TFTs in a step (615). If the default bearer has TFTs, then in a step (620), TFTs from unestablished dedicated bearers are transferred to the default bearer.

Then in a step (625), UE (100) is prevented from initiating QoS modifications until resource limitation is “OFF”. The step (625) may be accomplished by UE (100) by the NAS layer sending error notification to applications when QoS modifications are requested. The step (625) may be accomplished by NN (200) by rejecting QoS modification requests with an error cause. The step (625) may also be accomplished by UE (100) and NN (200) by other means.

In the event that resource limitation is “OFF” in a step (605), then unestablished dedicated bearer contexts are deactivated in a step (630) and then the UE is prevented from initiating QoS modifications in (625).

In the event that the default bearer context does not have TFTs in a step (615), then step (625) is performed directly.

“Details of Processing of Change in Limitation Bit-UE”

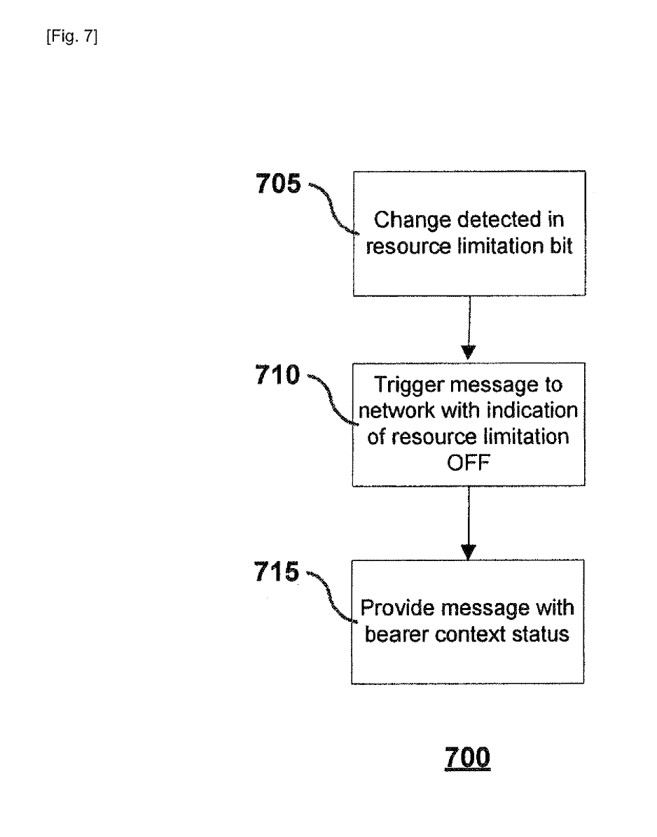

Flowchart (700) of FIG. 7 illustrates the operations comprising step (570) of processing the change in the presence of the limitation bit by UE (100). In a step (705), UE (100) detects change in the resource limitation bit. This step may be accomplished by means of RRC layer sending an indication to NAS layer.

Upon detecting the change in resource limitation status, UE (100) then triggers a message to the network, NN (200), to indicate the change in resource limitation. This may be accomplished by sending a tracking area update message, an extended service request message or a service request message.

Within the message to the network NN (200), UE (100) includes an indication of the bearer context status as in a step (715). The indication may be explicit in the form of a bearer context status information element or implicit in the form of a service request message sent when UE (100) is in connected mode.

“Details of Processing of Change in Limitation Bit-NN”

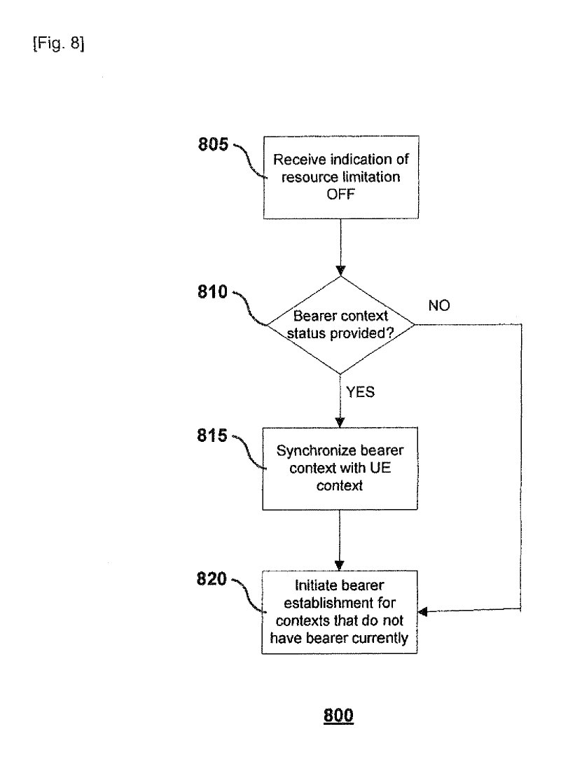

Flowchart (800) of FIG. 8 illustrates the operations comprising step (580) of processing the change in the presence of the limitation bit by NN (200). In a step (805), NN (200) receives indication that resource limitation is “OFF”. This step may be accomplished by NN (200) receiving a notification from UE (100). It may also be accomplished by NN (200) receiving notification from an external source or operator.

Then in a step (810), NN (200) checks if it has the status of bearer contexts from UE (100). If the check results in a positive result, NN (200) synchronizes its bearer contexts with those of UE (100) in a step (815). Then in step (820), NN (200) initializes bearer establishment for bearer contexts that do not currently have bearers.

In the event that bearer context status is not provided to NN (200) in a step (810), NN (200) proceeds to initialize bearer establishment for bearer contexts that do not currently have bearers.

### Embodiment 3

“NN Handling of Bearer Context Changes”

In another embodiment of the invention, filters for dedicated bearer contexts are marked upon receiving notification of resource limitation. Marked filters are saved as “frozen” context and then transferred to the default bearer according to step (545) of sequence 500 of FIG. 5. When any filter is deleted, the corresponding filter from the “frozen” context is also deleted. After resource limitation is removed, the new set of filters from the “frozen” context is synchronized with the NN (200) according to the steps (570) and (580). This embodiment ensures UE (100) and NN (200) can manage changes in filter configurations during the duration of resource limitation.

### Embodiment 4

“UE Apparatus”

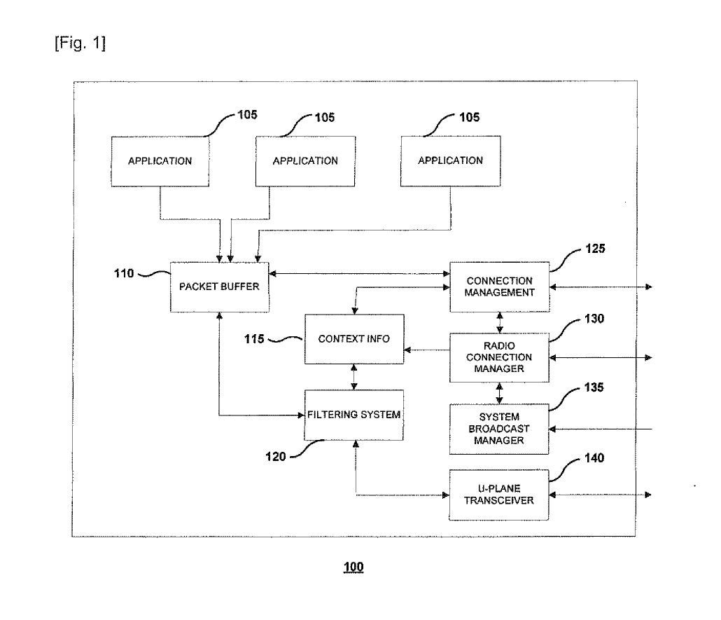

FIG. 1 illustrates the apparatus of UE (100) embodying the present invention. UE (100) comprises a number of modules, some of which are presented in FIG. 1. UE (100) generally operates in accordance with a singular or plurality of wireless technologies such as 3GPP LTE, UMTS and WiMAX.

Application (105) represent any Internet Protocol (IP) enabled applications. These include voice over IP (VoIP)), Internet browsing, video services etc. Application (105) are interfaced to a Packet Buffer (110) module. Packet Buffer (110) buffers packets from Application (105) for which there is no established bearer when UE (100) is in idle mode.

Packet Buffer (110) module interfaces with Connection Management (125) and Filtering System (120) modules. Connection Management (125) module establishes signaling connection with the network, including with NN (200). The module (125) interacts with lower layers such as RRC layer to check for availability of access control mechanisms. Connection Management (125) also provides information on bearer context status that it derives from context information. This information allows for bearer context synchronization with NN (200). In one aspect of the embodiment, Connection Management (125) derives bearer context status according to 3GPP TS 24.301 and 3GPP TS 24.008.

Filtering System (120) realizes the filters for IP packet flows. Uplink packets are filtered based on filters provided by context information and are mapped to corresponding radio bearers.

Context Info (115) module stores context information. Context information comprises bearer identifiers, TFTs, QoS etc. In accordance with this invention, Context Info (115) also stores information on “frozen” context and “temporary” context. This module creates “frozen” context when it realizes resource limitation is “ON” and when some dedicated bearers have not been established. “Frozen” context is the storage of current context. “Temporary” context is created by transferring filters to default bearer if the default bearer has TFT. When resource limitation is “ON”, Context Info (115) prevents UE (100) from requesting QoS modification. When resource limitation is “OFF”, Context Info (115) allows UE (100) to request QoS modification. This module also provides the Connection Management (125) module with QoS information when resource limitation is “OFF” and when resynchronization with NN (200) is required.

Radio Connection Manager (130) module establishes signaling connection with NN (200) and manages System Broadcast Manager (135). In one aspect of the embodiment, Radio Connection Manager (130) is similar to RRC layer of UE (100). This module informs the NAS layer about access control mechanisms such as access class barring or service specific application control (SSAC) if these are detected by the System Broadcast Manager (135).

The System Broadcast Manager (135) is a subfunction of the RRC layer that detects changes in system information. In accordance with this invention, the module (135) detects changes in the resource limitation bit and informs upper layers of the changes.

U-Plane Transceiver (140) is the module responsible for the transport of IP packets between UE (100) and NN (200).

### Embodiment 5

“NN Apparatus”

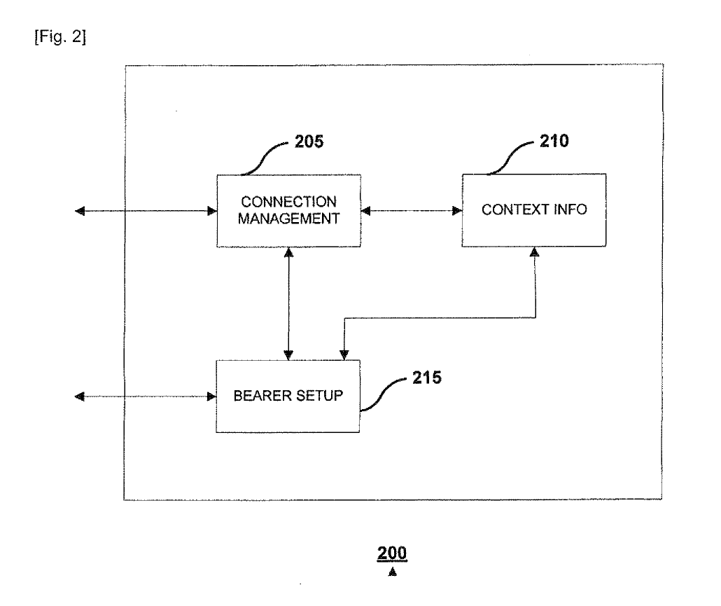

FIG. 2 illustrates the apparatus of NN (200) embodying the present invention. NN (200) comprises a number of modules, some of which are presented in FIG. 2. NN (200) generally operates in accordance with a singular or plurality of wireless technologies such as 3GPP LTE, UMTS and WiMAX. NN (200) may comprise of many additional functionalities which may be in different logical or physical nodes in the network. For instance, modules of NN (200) may be realized across MME, P-GW or any other network node.

Connection Management (205) module is the peer entity of Connection Management (125) module of UE (100). Connection Management (205) of NN (200) handles the initial establishment of the signaling connection with UE (100). This module detects the indication of resource limitation, whether “ON” or “OFF”. The module (205) also initializes bearer establishment when UE (100) indicates resource limitation is “OFF” with bearer context status.

Connection Management (205) interfaces with Context Info (210) and Bearer Setup (215) modules. Context Info (210) module stores context information. Context information comprises bearer identifiers, TFTs, QoS etc. In accordance with this invention, Context Info (210) also stores information on “frozen” context and “temporary” context. This module creates “frozen” context when it realizes resource limitation is “ON” and when some dedicated bearers have not been established. “Frozen” context is the storage of current context. “Temporary” context is created by transferring filters to default bearer if the default bearer has TFT.

Bearer Setup (215) initiates bearer setup for UE (100) when triggered by Connection Management (205). Connection Management (205) provides Bearer Setup (215) with the relevant bearer context information.

The aforementioned embodiments of the invention illustrate the applications of the invention for resource limitation in wireless networks.

1. A system of resource limitation comprising:
a UE that on enforcement of resource limitation by radio network, moves filters from bearer contexts corresponding to unestablished bearers to default bearer context when default bearer has a TFT and stops UE requested QoS modification procedure until resource limitation enforcement by the network has been removed, and a network node that is informed enforcement of resource limitation by radio network, moves filters from bearer contexts corresponding to unestablished bearers to default bearer when default bearer has a TFT.

2. The system according to claim 1, wherein the UE on detection of enforcement of resource limitation and unestablished bearers, stores the current context as a frozen bearer context for future synchronization with the network node.

3. The system according to claim 2, wherein the UE on detection of removal of enforcement of resource limitation, resynchronizes its bearer contexts with the network node.

4. The system according to claim 3, wherein the UE esynchronizes by explicit indication.

5. The system according to claim 3, wherein the UE esynchronizes by implicit indication of sending service request in connected mode.

6. The system according to claim 2, wherein each filter copied to the default filter is marked.

7. The system according to claim 6, wherein when a marked filter is deleted, the corresponding filter in the frozen bearer context is also deleted.

8. The system according to claim 1, wherein informed of a resource limitation enforcement and unestablished bearers, stores the current context for future synchronization with the UE.

9. The system according to claim 8, wherein the network node initiates bearer establishment for unestablished bearers on receiving a synchronization message by the UE consisting of an indication of the stop of resource limitation enforcement by the radio network.

10. A method of resource limitation enforcement comprising the steps of:
detecting by the UE of resource limitation enforcement by the radio network;
moving filters of unestablished bearers to default bearer in case of presence of TFT in default bearer;
stopping further UE requested QoS modification procedures until the resource limitation enforcement is stopped by the radio network;
indicating of resource limitation enforcement to the network node, and network node moving filters of unestablished bearers to default bearer in case of presence of TFT in default bearer.

11. The method according to claim 10, further comprises the steps of the UE storing the current bearer context as frozen bearer context information.

12. The method according to claim 11, wherein the bearer contexts corresponding to established bearers are referred to as temporary bearer context which remains the used bearer context until a next trigger.

13. The method according to claim 10, wherein the next trigger is the UE moving to idle mode.

14. The method according to claim 10, wherein the next trigger is the reestablishment of bearers corresponding to the bearer contexts in the frozen bearer context information.

15. The method according to claim 10, further comprises the steps of a UE synchronizing its frozen bearer context with the network node on detection of removal of resource limitation enforcement by the radio network, the network detecting the indication of removal of resource limitation enforcement and initiating the establishment of bearers that correspond to unestablished bearers in the frozen bearer context.

16. The method according to claim 10, further comprises the step where the UE marks each filter copied to the default bearer.

17. The method according to claim 13, further comprises the step of the UE deleting the corresponding filter in the frozen context when the filter in the default bearer is deleted.
